(19) United States
(12) Patent Application Publication
(10) Pub. No.: US 2019/0003978 A1
(43) Pub. Date: Jan. 3, 2019

(54) PROCESS AND APPARATUS TO DETECT MERCAPTANS IN A CAUSTIC STREAM

(71) Applicant: UOP LLC, Des Plaines, IL (US)

(72) Inventors: Yili Shi, Buffalo Grove, IL (US); Daliah G. Papoutsis, Glenview, IL (US); Jonathan A. Tertel, Mount Prospect, IL (US)

(21) Appl. No.: 16/007,669

(22) Filed: Jun. 13, 2018

Related U.S. Application Data
(60) Provisional application No. 62/525,868, filed on Jun. 28, 2017.

(51) Int. Cl. G01N 21/79; G01N 1/38

(52) U.S. Cl. CPC G01N 21/79; G01N 1/38

(57) ABSTRACT

The present invention relates to a system to detect mercaptides or sulfides in a caustic stream. More particularly, this invention relates to an on-line analyzer for measuring mercaptides using a color changing reagent to quantify mercaptide or sulfide concentration in a caustic stream. The on-line analyzer which includes a liquid sensor which can provide valuable feedback to an operator for controlling a processing unit for the catalytic oxidation of mercaptides to disulfides in an alkaline environment.

### CROSS-REFERENCE TO RELATED APPLICATION

This application claims priority from Provisional Application No. 62/525,868 filed Jun. 28, 2017, the contents of which cited application are hereby incorporated by reference in its entirety.

### BACKGROUND

The present invention relates to a system to detect mercaptide or sulfide concentration in a caustic or other aqueous alkaline stream. More particularly, this invention relates to an on-line analyzer for measuring mercaptans using a color changing reagent to quantify either mercaptide or sulfide concentration in a caustic aqueous stream. The on-line analyzer which includes a liquid sensor which can provide valuable feedback to an operator for controlling a unit where catalytic oxidation of mercaptans to disulfides or sulfides to sulfates in an alkaline environment.

Petroleum refining and petrochemical processes frequently involve treating processes for removing sulfur compounds from hydrocarbon streams. In these processes, mercaptans or hydrogen sulfide present in a liquid hydrocarbon stream such as natural gas, naphtha, or liquid petroleum gas are extracted into an aqueous alkaline solution to form mercaptide or sulfide species. The extracted mercaptans may be oxidized to disulfide compounds.

The extractive Merox process oxidizes mercaptans in a caustic stream to disulfides, as a separation process. The concentration of mercaptides in caustic is an important piece of data to monitor the operations of the unit, determine if adjustments need to be made, or to prevent upsets. The current analytical method uses off-line laboratory analysis to measure the value. This analysis, however, is difficult to run and labs may run it infrequently. There is also a manual test (shake test) that can be done at the unit, but the results are very qualitative and have issues with reproducibility. Further, current systems use an electrode system, which has limitations and only applies to mercaptides.

### SUMMARY

The present invention is a process and apparatus for measuring mercaptides using a color changing reagent to quantify mercaptide or sulfide concentration in a caustic stream. Proposed herein is an on-line analyzer which includes a liquid sensor which can provide valuable feedback to an operator for controlling a unit where catalytic oxidation of mercaptides to disulfides in an alkaline environment. Also, the same type of analyzer can be used for on-line sulfide analysis in an amine unit, a Selexol unit, caustic wash stream, etc. Additionally, the same type of analyzer can be used in on-line gas analysis for sulfides and mercaptides in a Natural Gas Molecular Sieve Unit or any unit having a gas stream needing mercaptide/sulfide analysis, though this unit would have an additional step of passing the gas sample through an alkaline stream and testing the alkaline stream. These units would also have operational benefits from on-line analysis of sulfide concentration.

An embodiment of the invention comprises a process for detecting mercaptides or sulfides in a caustic (or aqueous alkaline) stream comprising obtaining a sample from a caustic stream; diluting the sample; adding a chemical titrant to the sample; measuring UV and/or visible light absorbance of the sample; transmitting data of the sample; and sending the remaining caustic back to the unit.

An additional embodiment of the invention comprises a system for detecting mercaptides in a caustic stream comprising a liquid sensor to obtain a sample of a caustic stream in direct communication with a processing unit; a diluting device; a chemical titrant; and an analyzer having a sensor for transmitting data.

### BRIEF DESCRIPTION OF THE DRAWINGS

FIG. 1 is a schematic view of the on-line analyzer for measuring mercaptides using a color changing reagent to quantify mercaptide sulfide concentration in a caustic stream.

FIG. 2 is a plot of light absorbance at 412 nm versus various concentrations of ethyl mercaptide quenched with 5,5′-dithiobis(2-nitrobenzoic acid).

### DETAILED DESCRIPTION

The present invention use a color-changing reagent as part of the sensor to quantify mercaptide/sulfide concentration. Related art uses an electrode system, which may have limitations and would be limited to only mercaptides. The invention benefits operations by preventing upsets, using less catalyst, lowering reaction temperature. The invention would be a liquid sensor that automatically takes samples from an operating unit. The sample would be “quenched” in the analyzer with 5,5′-dithiobis(2-nitrobenzoic acid) which generates a yellow color. The yellow color is proportional to mercaptide/sulfide content. A visible wavelength detector measures the light absorbance and returns a mercaptide concentration. The analyzer sample is sent to a waste container and the analysis can begin again.

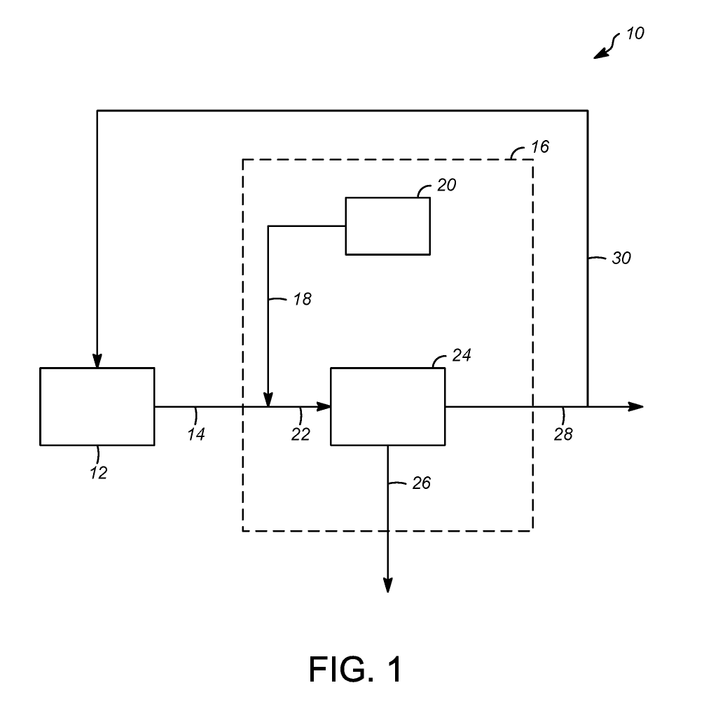

As illustrated in FIG. 1, the system for detecting mercaptides in a caustic stream 10 includes a unit 12 is a unit where catalytic oxidation of mercaptides to disulfides in an alkaline environment. A small liquid line 14 is taken from the unit 12 for sampling in a sampling zone 16. The sample may be diluted with about 10 mL to about 25 mL of water. A quench solution 18 includes a chemical titrant such as 5,5′-dithiobis(2-nitrobenzoic acid) is added to the liquid sample 12 to produce the quenched sample 22. The quenched sample 22 is exposed to light source 24 which produces an absorbance value which can be used to calculate mercaptide or sulfide concentration data 26. The concentration data 26 is transmitted to a user via a sensor or any other transmitting device. In another embodiment, other chemical titrants can be used such as 4,4′-dithiodipyridine can be used to induce a color change. In yet another embodiment, the chemical titrants, such as 7-fluorobenzofurazan-4-sulfonate or 4-fluoro-7-sulfamoylbenzofurazan, can produce a fluorescence signal upon reaction with mercaptides. The waste stream 28 may be discarded or waste stream 28 may be recycled back to the unit 8.

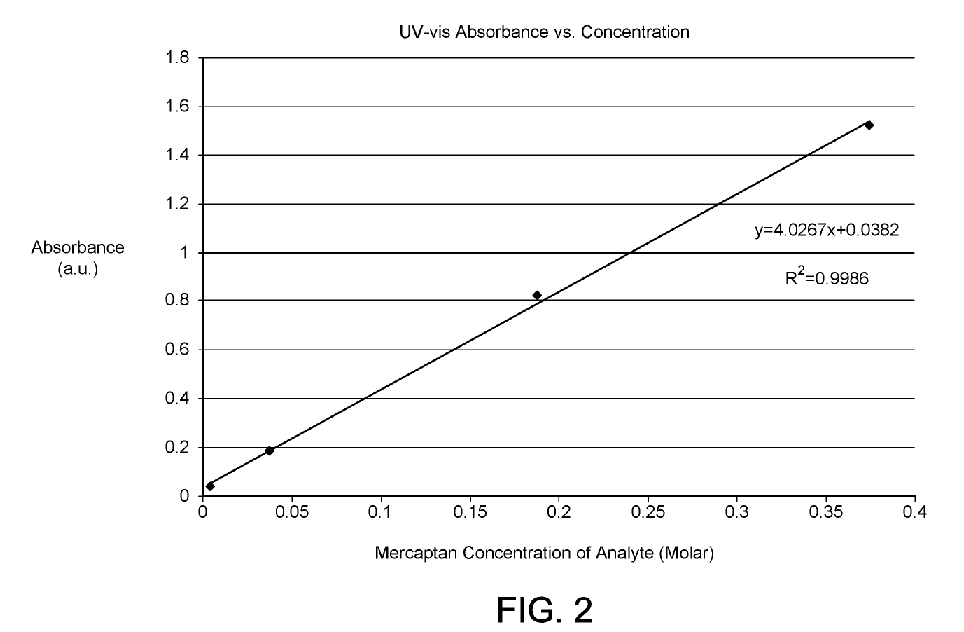

FIG. 2 is a plot of light absorbance at 412 nm versus various concentrations of ethyl mercaptide quenched with 5,5′-dithiobis(2-nitrobenzoic acid).

It should be noted that various changes and modifications to the presently preferred embodiments described herein will be apparent to those skilled in the art. Such changes and modifications may be made without departing from the spirit and scope of the present subject matter and without diminishing its attendant advantages.

### Specific Embodiments

While the following is described in conjunction with specific embodiments, it will be understood that this description is intended to illustrate and not limit the scope of the preceding description and the appended claims.

A first embodiment of the invention is a process for detecting mercaptides or sulfides in a caustic (or aqueous alkaline) stream comprising obtaining a sample from a caustic stream; diluting the sample; adding a chemical titrant to the sample; measuring UV and/or visible light absorbance of the sample; transmitting data of the sample; and sending the remaining caustic back to the unit. An embodiment of the invention is one, any or all of prior embodiments in this paragraph up through the first embodiment in this paragraph wherein the sample comprises about 0.000035 M to about 3.5 M concentration of sulfurous analyte. An embodiment of the invention is one, any or all of prior embodiments in this paragraph up through the first embodiment in this paragraph wherein the sample is diluted with water. An embodiment of the invention is one, any or all of prior embodiments in this paragraph up through the first embodiment in this paragraph wherein the sample volume is diluted with water between 1 to 20,000 fold. An embodiment of the invention is one, any or all of prior embodiments in this paragraph up through the first embodiment in this paragraph wherein the chemical titrant is 5,5′-dithiobis(2-nitrobenzoic acid). An embodiment of the invention is one, any or all of prior embodiments in this paragraph up through the first embodiment in this paragraph wherein 5,5′-dithiobis(2-nitrobenzoic acid)is added in an aqueous buffer or organic solution. An embodiment of the invention is one, any or all of prior embodiments in this paragraph up through the first embodiment in this paragraph wherein a sample of caustic solution may be obtained at any time.

A second embodiment of the invention is a system for detecting mercaptides in a caustic stream comprising a liquid sensor to obtain a sample of a caustic stream in direct communication with a processing unit; a diluting device; a chemical titrant; and an analyzer having a sensor for transmitting data. An embodiment of the invention is one, any or all of prior embodiments in this paragraph up through the second embodiment in this paragraph wherein the processing unit is a mercaptan treating unit (e.g. Merox). An embodiment of the invention is one, any or all of prior embodiments in this paragraph up through the second embodiment in this paragraph wherein the processing unit is an Amine unit. An embodiment of the invention is one, any or all of prior embodiments in this paragraph up through the second embodiment in this paragraph wherein the processing unit is a Selexol unit. An embodiment of the invention is one, any or all of prior embodiments in this paragraph up through the second embodiment in this paragraph wherein the processing unit is a caustic wash. An embodiment of the invention is one, any or all of prior embodiments in this paragraph up through the second embodiment in this paragraph wherein the analyzer is configured to detect mercaptide concentration. An embodiment of the invention is one, any or all of prior embodiments in this paragraph up through the second embodiment in this paragraph wherein the analyzer is configured to detect sulfide concentration. An embodiment of the invention is one, any or all of prior embodiments in this paragraph up through the second embodiment in this paragraph wherein the analyzer is configured to detect mercaptide and sulfide concentration. An embodiment of the invention is one, any or all of prior embodiments in this paragraph up through the second embodiment in this paragraph further comprising recycling any remaining sample back to the processing unit. An embodiment of the invention is one, any or all of prior embodiments in this paragraph up through the second embodiment in this paragraph further comprising wherein the analyzer measures fluorescence response of processing unit is a chemical titrant. An embodiment of the invention is one, any or all of prior embodiments in this paragraph up through the second embodiment in this paragraph wherein the processing unit is any unit having a gas stream needing mercaptide/sulfide analysis.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process for detecting mercaptides or sulfides in a caustic (or aqueous alkaline) stream comprising:
obtaining a sample from a caustic stream;
diluting the sample;
adding a chemical titrant to the sample;
measuring UV and/or visible light absorbance of the sample;
transmitting data of the sample; and
sending the remaining caustic back to the unit.

2. The process of claim 1 wherein the sample comprises about 0.000035 M to about 3.5 M concentration of sulfurous analyte.

3. The process of claim 1 wherein the sample is diluted with water.

4. The process of claim 3 wherein the sample volume is diluted with water between 1 to 20,000 fold.

5. The process of claim 1 wherein the chemical titrant is 5,5′-dithiobis(2-nitrobenzoic acid).

6. The process of claim 5 wherein 5,5′-dithiobis(2-nitrobenzoic acid)is added in an aqueous buffer or organic solution.

7. The process of claim 1 wherein a sample of caustic solution may be obtained at any time.

8. A system for detecting mercaptides in a caustic stream comprising:
a liquid sensor to obtain a sample of a caustic stream in direct communication with a processing unit;
a diluting device;
a chemical titrant; and
an analyzer having a sensor for transmitting data.

9. The system of claim 8 wherein the processing unit is a mercaptan treating unit (e.g. Merox).

10. The system of claim 8 wherein the processing unit is an Amine unit.

11. The system of claim 8 wherein the processing unit is a Selexol unit.

12. The system of claim 8 wherein the processing unit is a caustic wash.

13. The system of claim 8 wherein the analyzer is configured to detect mercaptide concentration.

14. The system of claim 8 wherein the analyzer is configured to detect sulfide concentration.

15. The system of claim 8 wherein the analyzer is configured to detect mercaptide and sulfide concentration.

16. The system of claim 8 further comprising recycling any remaining sample back to the processing unit.

17. The system of claim 8 further comprising wherein the analyzer measures fluorescence response of processing unit is a chemical titrant.

18. The system of claim 8 wherein the processing unit is any unit having a gas stream needing mercaptide/sulfide analysis.
